(19) United States
(12) Patent Application Publication
(10) Pub. No.: US 2012/0191467 A1
(43) Pub. Date: Jul. 26, 2012

(54) DIAGNOSTIC IDENTIFICATION, EVALUATION AND MANAGEMENT OF POLYVASCULAR DISEASE AND RELATED CONDITIONS

(75) Inventors: Paulita M. LaPlante, Inver Grove Heights, MN (US); Daniel J. Bartnik, Eden Prairie, MN (US); Rose A. Griffith, Eden Prairie, MN (US); Jerome S. Tannenbaum, Nashville, TN (US)

(73) Assignee: VASAMED, INC., Eden Prairie, MN (US)

(21) Appl. No.: 13/322,679

(22) PCT Filed: May 26, 2010
(86) PCT No.: PCT/US10/36146

§ 371 Date: Nov. 28, 2011

(30) Foreign Application Priority Data
May 27, 2009 (US) 61181497
Aug. 18, 2009 (US) 61234846

(51) Int. Cl. G06Q 50/22

(52) U.S. Cl. 705/2

(57) ABSTRACT

One aspect of the present invention provides an electronic system accessible via a collaborative subscription service to facilitate improved access and analysis of patient data relevant to Polyvascular disease. In one specific embodiment, the electronic system is used by physicians and health care service providers to aggregate relevant medical data points, as the electronic system provides recommendations and analysis of patient care for specific Polyvascular symptoms and conditions. These data points are collected through appropriate medical devices and are transmitted for storage and access within the operational environment. One embodiment of the service also enables a collaborate environment for communication between various health care providers, professionals, and the patient regarding specific patient conditions. Accordingly, improved diagnosis, treatment, and monitoring of the various conditions related to Polyvascular disease can be deployed for the patient.

### FIELD OF THE INVENTION

The present invention generally relates to the field of medical information processing. The present invention more specifically relates to diagnostic evaluation and treatment management methods, systems, and devices used to address Polyvascular disease and its related medical conditions.

### BACKGROUND OF THE INVENTION

Polyvascular Disease: A Complex Problem & Fractured Management

Peripheral Arterial Disease (PAD) is common and its incidence increases as the general population ages, as Diabetes Mellitus (DM, commonly referred to as simply “Diabetes”) escalates and as the improved identification and awareness of asymptomatic PAD becomes reality. While the term “PAD” refers to any pathologic process that causes obstruction in arterial blood flow exclusive of the coronary and cerebral vessels, approximately 16% of patients with PAD have other incidental atherosclerotic changes in the brain such as Cerebrovascular Disease (CVD) and/or in the heart in the form of Coronary Artery Disease (CAD). Overall, PAD patients are 4 to 5 times more likely to die of a cardiovascular event. This rate translates to a mortality risk that is 2-3 times greater than observed in non-PAD patients. Hypertension (HTN) precedes the development of heart failure (HF) in 91 percent of cases, and is associated with a 2-3 times higher risk for developing HF. Further, hypertension is a comorbidity in approximately 69% of people who have a first heart attack, 77% who have a first stroke, and 74% with heart failure. PAD patients have a 5.9 times higher risk for death from cardiovascular disease complications and a 6.6 times higher risk for death from congestive HF specifically.

Ultimately this means that PAD should be considered within the broader context of systemic “Polyvascular Disease” which results in conditions causing amputations, strokes, kidney disease, and death. As generally known and referred to herein, Polyvascular Disease refers to a condition of diseases occurring in multiple arterial locations.

Polyvascular Disease in the United States

Compelling statistics underscore the tremendous burden that Polyvascular Disease conditions place upon U.S. healthcare providers and insurers. Between 8 and 12 million Americans have PAD; this includes 10-20% of the U.S. senior citizen population.

About half of all people with PAD are asymptomatic. Among this population, 5 to 10% develop symptomatic PAD over 5 years. Symptomatic PAD patients have a very high rate of mortality (25%-30% within 5 years); 5 MM Americans have heart failure with 400K-700K new cases diagnosed annually; 200,000 die of HF each year; less than 50% of HF patients are living 5 years after their initial diagnosis; less than 25% are alive at 10 yrs; and 1MM hospitalizations occur each year at a cost of over $7 Billion.

Further, 65 MM Americans have Hypertension (HTN). Literature shows that 46% of patients actively treated for HTN do not have clinical control over their blood pressure and 69% of all patients with HTN do not have clinical control over their blood pressure.

The complexity of Polyvascular Disease is confounded by Diabetes Mellitus (DM): A Syndrome within a Syndrome.

One in three patients with Diabetes Mellitus (DM) also has PAD. Just as with Polyvascular Disease, DM itself is more correctly described as a syndrome of many other components that are related to insulin resistance; this includes obesity, hypertension, dyslipidemia, hyperinsulinemia, and hyperglycemia.

DM and CVD go hand-in-hand. In a seven-year follow up study of over 1,000 patients in two study groups (with and without DM), patients with DM had a 20% incidence of myocardial infarction during the study period whereas there was only a 4% incidence among patients without DM.

Additionally, patients with DM and PAD are more likely to develop lower extremity (LE) ulcers. These can be among the most difficult ulcers to heal particularly if they are venous in origin. Ulcers that are chronic, i.e., failure to progress after 12 weeks of appropriate treatment, present the greatest clinical challenge and are the most expensive to manage. According to the Centers for Disease Control, 14.6 MM Americans have been diagnosed with Diabetes Mellitus and another estimated 6.2 MM Americans have the disease but remain undiagnosed (totaling 7% of the American population).

Peripheral neuropathy frequently occurs with DM and leads to foot ulcers (100,000 of total 600,000 per year LE ulcer diagnoses). Foot ulcers lead to amputations. There are approximately 82,000 non-traumatic amputations performed annually that are attributed to DM totaling 60% of the non-traumatic lower-limb amputation rate. The prevalence of lower extremity amputation for patients with DM and Chronic Kidney Disease (CKD) is much greater than for patients without CKD.

Total direct costs of treating a DM foot ulcer range from $10,000 to $60,000. Significantly, 50-70% of patients who have amputations will die within 5 years of the event with the rate being exacerbated by age, cardiovascular and renal disease, and location of amputation.

It is therefore incumbent upon healthcare providers to consider DM Syndrome as part of the larger syndrome of Polyvascular Disease and to understand that one cannot ignore the patient's feet or legs any more than their kidneys or heart.

Diagnosing the Extent of Disease and then Selecting and Monitoring Treatment Requires Resource and Patient Orchestration.

The staggering number of PVD and DM patients overlaid with the complexity of both these disease syndromes as well as treatment modalities demands cost-effective solutions wherein “cost-effective” is inclusive of turn-around-time, human and capital resource requirements, reimbursement and clinical utility. However, the prevailing approach to managing this challenging and increasingly expensive situation of PVD is to compartmentalize patient care.

The patient's primary physician may not be aware or motivated to refer the patient. The primary physician may lack effective tools to diagnose disease early. Care is delayed for symptomatic patients until they present more complex conditions, which often results in increasingly difficult to manage scenarios evidencing not only higher risks but also greater financial burdens. Care is further fragmented due to poor coordination between referring physicians and interventionists (CV surgeons, cardiologists, radiologists).

Some wound care and/or diabetic foot clinicians prematurely direct patients to therapy prior to evaluating the patient for underlying occlusive disease. Dialysis centers are faced with increased pressure to manage more CKD and End-Stage Renal Disease (ESRD) patients with less money, yet morbidity requiring hospitalization frequently results in a revenue decrease to the center and increased mortality risk for the patient. This is especially true for the patient with both DM and CKD or ESRD. Likewise, Dialysis centers are charged with providing monitoring services to their patients in order to prevent/minimize additional morbidity and mortality (diabetic foot assessment, vascular access patency) but often have insufficient resources to deliver such service.

The co-morbidities of Polyvascular disease can conceal PAD and wound healing potential from current methods of non-invasive diagnosis or make these issues a lower priority. There is a general lack of interest, purchasing will, and/or available staff to integrate customized electronic medical record systems as a method to ensure rapid communication, coordinated care, and follow-up after PAD intervention.

This seemingly insurmountable list of objections and barriers to care has a unifying theme, and that is “pay-for-performance.” As a healthcare mandate, all parties agree on reimbursement for results but not on implementation. Additionally, there are broad regional variations in spending for content of care (effective care, preference sensitive care, supply sensitive services). Nonetheless most institutions mistakenly believe that they are effectively preparing to meet or exceed legislation on the topic.

What is needed is the application of enhanced techniques to better treat and manage the diagnosis, care, and maintenance of patients with Polyvascular disease and its related conditions. Particularly, what is needed in the art are diagnostic methods, systems, and devices capable of identifying, evaluating, and managing patient care of Polyvascular disease between multiple health care providers. Only with such coordinated care may medical providers supply the highest performance of care and effectively address the most common aspects and problems from Polyvascular disease.

### BRIEF SUMMARY OF THE INVENTION

The proliferation of novel peripheral revascularization technology options coupled with electronic communication mechanisms coupled with the growing need for dialysis, renal care, wound care and heart failure services coupled with pay-for-performance standards provide a needed opportunity to establish an effective collaborative service for patient care management of Polyvascular disease. The various aspects of the present invention enable the establishment of such a collaborative service, to facilitate improved access and analysis of patient data relevant to Polyvascular disease between physicians, health care service providers, and patients.

One aspect of the present invention provides a diagnostic service program to unify patient care occurring at disparate medical providers. The diagnostic service program operates to address relevant data points and the current state of care of a patient from a number of different medical providers, including primary care physicians, interventionists, surgeons, specialists, care centers, specialty clinics. As a specific example, in one embodiment, the diagnostic program unifies the identification of PAD and Diabetic foot ulcer conditions for patients obtaining regular treatments in Dialysis Clinics. The diagnostic program can then refer the patient to appropriate treatment of the condition in Wound Care Clinics and/or Limb Preservation Practices.

Another aspect of the present invention involves providing a range of services within a “network” of interested health providers and parties via a computer network-connected collaborative environment. This collaborative environment provides access to and compilation of diagnostic tests, patient data, electronic medical records, evaluative diagnoses and comments, outcome, and other information relevant to the patient's medical condition that has been converted into an electronic form. This collaborative environment enables multiple medical providers to share data with each other, and direct their attention and inquiries to further diagnosis and prevention of additional complexities of Polyvascular disease and its related conditions. The collaborative environment further directs attention to a specific patient through comprehensive inquiry of the patient's condition, and provides care recommendations and guidelines for enhanced patient treatment.

In additional embodiments of the present invention, data collected from relevant medical devices is collected, aggregated, and processed for use in the diagnosis and/or treatment of Polyvascular disease. This data is input into the collaborative environment for further processing and attention by both medical providers and automated algorithms. Specifically, these medical devices provide input to the system relevant to data values directly collected from the patient, which is stored in electronic medical records and/or a database specific to the collaborative environment. Once collected, this data can be analyzed for further indications of Polyvascular disease-related conditions, and/or the data can be directly provided, shared, and interpreted among multiple healthcare providers participating in the collaborating environment. Further embodiments may also provide a central server that receives regional data from a plurality of sources.

As non-limiting examples of relevant medical devices, the SENSILASE® diagnostic system can be used to perform an assessment of microvascular health in a patient, the MICROSTAT® tissue capnometry system can be used to perform an assessment of diminished perfusion in tissue, and the AcQTRAC® cardiovascular monitor can be used to assess heart failure and hypertension management. Each of these systems is relevant to the diagnosis and/or measurement of Polyvascular disease, and may indicate the progression of a related Polyvascular condition. Data collected from these devices may be transmitted and stored within a database, and directly correlated with other input data to specific stages of Polyvascular conditions. For example, patients with lower extremity ulcers must have adequate lower extremity perfusion to allow healing to occur. Perfusion inadequacy can be due to local, regional, or systemic problems. The SENSILASE® system can detect local perfusion problems; the MICROSTAT® system can detect regional perfusion abnormalities; and the ACQTRAC® system measures systemic changes in perfusion. Other medical measures could include glucose, blood pressure, and anide-brachial index (ABI) tests. The data can be correlated to guide healthcare providers to assure that the entire scope of the patients perfusion status is being monitored and adequately maintained. Cross-referencing of the measurements and information can further be accomplished by Bayesian probability statistics, fuzzy logic, or other advanced mathematical techniques.

Improved treatment of peripheral vascular disease may also occur through the use of smart diagnostic algorithms accessible within the collaborative system. These smart diagnostic algorithms direct additional attention to a patient's condition, allowing evaluation algorithms to directly recommend additional tests and measure relevant preceding treatments. For example, if a patient's skin perfusion pressure is trending down over time following a peripheral percutaneous intervention while concomitant measures of cardiac output and sublingual CO₂ remain unchanged, it may signal imminent, local re-occlusion of a peripheral artery. This can trigger intervention prior to recurrence of an ulcer, which carries a higher cost of treatment and higher risk to the patient.

In one specific embodiment, this collaborative diagnostic service program is referred to as the Diagnostic Identification, Evaluation, and Management Service (“DIEMS”). This program attempts to unite disparate physician service groups and their mutual interest in preserving patients' limbs and improving quality of life, and connect information and medical expertise in ways not previously available to a provider or patient. The transmission and use of relevant patient data between medical providers within a collaborative environment enables improved patient care and prevents data from not being analyzed. Within the DIEMS environment, data from multiple sources are communicated, aggregated (i.e., compiled and analyzed as a whole) and shared between physicians to document the progression of any developing conditions, and atypical events within the data are highlighted. Physician outcome data is also aggregated in a useful format to be analyzed by primary providers and other ancillary medical care professionals. Aggregated data provides useful insights into trends. Additionally, aggregate data may be used by insurers and/or government policy agencies either to develop pay-for-performance policies or as a metric of successful healthcare initiatives.

In further embodiments, the collaborative environment is delivered through an electronic overlay which aggregates data and communicates test results directly to participating physicians. This may take the form of a combination of a collaborative website and proprietary communication software. The DIEMS system may further provide its information through online website formats that contain separate interfaces for physicians, patients, and other interested parties. Electronic patient data served through the website is secured through appropriate data safeguards as required by HIPAA, and access to the relevant medical data stores is further controlled based on the type of medical provider and defined permissions.

A hub-and-spoke communication system may be also utilized to communicate between doctors and medical practices within the system as necessary, for example, between the primary physician and the referring physician who interprets the results. The physicians who care for Polyvascular disease patients are not typically in the same office or even within a shared practice. This means that they do not share patient information tracking systems and therefore cannot track diagnostic test efficacy (time, accuracy, cost) coupled with targeted therapeutic intervention outcome. Additionally, the physicians frequently repeat tests, are not aware of each other's clinical objectives, and fail to adequately follow-up with the patient once they have provided their service. Therefore, data acquisition that can be used to provide timely clinical feedback is typically unavailable.

Because Polyvascular disease patients are chronically sick and consume a disproportionate share of healthcare dollars, a hub-and-spoke communication network dedicated to these patients can dramatically improve patient management, decrease costs, and improve patient lives. The hub-and-spoke network may utilize wired and wireless communication methods, and different methods can be used for different channels within the network. Wired communication methods could include, but are not limited to: Ethernet, RS-232, RS-485, twisted-pair, and proprietary wired channels. Wireless communication methods could include, but are not limited to: Bluetooth, 802.11b, 802.11a, 802.11g, 802.11n, IrDA, digital transmission via cell phone transmission, text messaging, satellite transmission, and proprietary wireless channels.

In further embodiments, the DIEMS system enables, recommends, and manages a plan of patient care for at-risk and diagnosed patients. For example, the patient may manage scheduling of treatment through the system. The patient may also view and follow up with the results of tests and specific recommendations provided by the health care provider. Therefore, the DIEMS system is able to provide management of patient care from the perspective of each of the numerous health care providers and the patient themselves.

### BRIEF DESCRIPTION OF THE DRAWINGS

FIG. 1 depicts an example configuration of an online collaborative environment for performing diagnostic identification, evaluation, and management of Polyvascular disease in accordance with an embodiment of the present invention;

FIG. 2 depicts an example configuration of a Wound Care Center Hub with Spoke Network Partners utilizing an online collaborative environment in accordance with an embodiment of the present invention;

FIG. 3 depicts an example configuration of an electronic communications system and the interaction between various medical providers in an online collaborative environment in accordance with an embodiment of the present invention;

FIG. 4A depicts an example user interface of an electronic communications system used for accessing patient studies in accordance with an embodiment of the present invention;

FIG. 4B depicts an example user interface of an electronic communications system used for accessing specific patient study data in accordance with an embodiment of the present invention;

FIGS. 4C-4D) depict example user interfaces of an electronic communications system displaying graphical patient study data in accordance with an embodiment of the present invention;

FIG. 4E depicts an example user interface of an electronic communications system configured to display and receive text from an evaluating physician in accordance with an embodiment of the present invention; and

FIG. 5 depicts a vascular specialist model facilitating communications between a plurality of medical providers through use of an electronic communications system in accordance with one embodiment of the present invention.

### DETAILED DESCRIPTION OF THE INVENTION

One aspect of the present invention provides an integrated system for the diagnosis, identification, evaluation, and management of Polyvascular disease and its related conditions. This system, hereinafter referred to as the “DIEMS” solution, provides a targeted identification, perfusion evaluation, and management service of peripheral arterial disease at the numerous points-of-care that a patient encounters during treatment. This electronic system manages access to the various data that is collected by the various healthcare providers visited by the patient, and performs additional calculations and recommendations in order to enhance patient care.

The following disclosure explains both the goals and the implementation details of a fully integrated DIEMS solution. It is apparent that many of the following steps may be customized, modified, removed, substituted, or supplemented to adapt to the individualized care needs of a particular patient and the resources available from a medical provider.

Patient Care Goals of the DIEMS Solution

Some of the advantages and goals of successful implementation of the various embodiments of the present invention are as follows:

To foster cooperation and communication across specialty care providers who are responsible for diagnostic identification, evaluation and management of patients with DM—PVD syndrome;

To provide a locus for outcome accountability as the patient receives care across multiple care providers, which can be used to demonstrate the success of an organized multidisciplinary approach to diagnosis, treatment and monitoring; and

To share a uniformly applied resource and its costs between these providers in order to provide the highest quality service at the best price.

In one embodiment, the DIEMS solution may be implemented through the use of a subscription business model, such as a service administered by an independent third party. The collaborative group of the participating medical providers within a DIEMS solution implementation is hereinafter referred to as “DIEMS Partners.”

In this embodiment, the DIEMS Partners service will afford its clients access to a harmonized methodology that provides their patients with basic diagnostic, monitoring, and communication services staffed by its accredited personnel. The primary goal of this unique service is to create a seamless system where patients presenting with a limb threatened by vascular compromise will enjoy complementary and overall improved outcomes through receipt of timely diagnosis and appropriately managed treatment prior to resumption of their referring physician/clinic focused care plan.

The DIEMS Partners service enables its subscribing medical provider clients to advertise this service as a powerful value-added marketing tool. Thus, providers such as a Dialysis Center, Wound Care Clinic, or Limb Preservation Program may increase the benefits that they can provide the rapidly aging, increasingly co-morbid population they serve.

Cost-effective treatment plans are those that are developed early in a disease process. Early detection means early intervention and early intervention leads to better outcomes. This remains true even in the presence of several, severe co-morbidities as is the case with patients suffering from DM-CKD/ESRD.

Patient Testing

To properly diagnose and treat the various conditions of Polyvascular disease, appropriate tests need to be performed to verify and diagnose the patient's medical condition. In one embodiment, the DIEMS solution is prescribed by nephrologists for patients under their care at their clinic or in a dialysis clinic. DIEMS Partners employees test patients on a routine basis as indicated by their underlying disease condition(s) and per protocol, the nephrologist refers the patient to further evaluation and/or treatment as determined by DIEMS testing. These diagnostic tests include: skin perfusion pressure, diabetic foot monitoring, vascular access patency assessment, local malperfusion, glucose levels, and cardiovascular risk markers. Because the results of these tests can be relied upon to accurately detect disease and to forecast outcome, the timely performance of these tests is urgently needed where patients are routinely seen.

The test service portfolio offered within the DIEMS Partners service model does not include invasive or lengthy tests; none of the tests require special testing facilities and most tests can be provided in conjunction with other needed services. Data collected from any combination of the following modalities may be shared among the various providers and aggregated. Data can be used to track time-to-treatment and treatment outcome as well as to provide more detailed analysis such as specific dialysis clinic health statistics, outcome associated with specific types of treatment, rates of ulcer recurrence over time, cardiac and hypertension management and effect on ulcer recurrence, tissue perfusion and effect on ulcer recurrence, and the like.

As examples of the tests available within a test service portfolio, tissue perfusion and cardiovascular tests may be conducted along with an oral Vascular History taking. This not only tags patients at high risk for PAD/CAD, but these tests also permit accurate diagnosis of patients with PAD or small vessel foot disease which may go undetected for an extended time period simply because of where they are being seen and what is obscuring their PAD from early detection.

This is especially valuable for patients with long duration DM, smokers, CKD-ESRD and uncontrolled hypertension.

DIEMS tissue perfusion and diabetic foot assessment tests enable accurate prediction of wound healing potential when a foot ulcer is present. Patients with lower extremity wounds rely on services that permit them to minimize time-to-healing. Patients receiving hemodialysis treatment substantially benefit from safeguarding against morbidity that requires their hospitalization.

The DIEMS mucosal tissue assessment test is a unique, early detection tool for patients on dialysis who are prone to intradialytic hypoperfusion, thus minimizing the potential for a potentially fatal and always costly event.

DIEMS digit perfusion and arm pressure tests provide early warning of vascular access collapse, suspected subclavian arterial stenosis, or vascular access steal syndrome, all of which typically go unmanaged or undetected until either becoming symptomatic or an adverse event occurs.

DIEMS glucose tests using smart phone transmit and receive capabilities provides improved patient, provider, physician, and caregiver control.

Collecting Data from Numerous Health Providers

The opportunity to unify key health services for these patients is particularly needed. For example, many Limb Preservation Programs are obviously well-positioned to receive referrals of patients from care settings that manage co-morbid conditions that accompany “hidden” PAD, lower extremity ulcers, chronic kidney disease (CKD) and end-stage renal disease (ESRD). Similarly, Wound Care Clinics are poised to rapidly accept referrals and deliver care to heal lower extremity ulcers that become relegated to a lower priority status secondary to patients struggling with tri-weekly dialysis appointments.

The challenge for transmitting data is to utilize effective and available modes of communication. Wired and wireless communication methods can be used, and different methods can be used for different channels within the network. Wired communication methods may include, but are not limited to: Ethernet, RS-232, RS-485, twisted-pair, and proprietary wired channels. Wireless communication methods could include, but are not limited to: Bluetooth, 802.11b, 802.11a, 802.11g, 802.11n, IrDA, digital transmission via cell phone, text messaging, satellite transmission, and proprietary wireless channels. As an example, a diagnostic device (for example, a glucose sensor) could communicate by Bluetooth to a patient's cell phone, which would then communicate by cell phone transmission to the network. Results, alerts, or appointment reminders likewise could be provided from the network to the patient by text messages or other direct communications.

The challenge is to standardize diagnostic and monitoring algorithms for these patients, enable and coordinate communication, and ensure timely referrals in order to make an appreciable difference in limb loss and other morbidity—and in the process, save time and money. With thousands of clinical service sites in the U.S. struggling with the dichotomy of increased financial burdens and operating within already constrained budgets, the services provided within the DIEMS Partners program (specifically, its hub-and-spoke network service) proposes a methodology to address the challenges. This empirically defined method of uniting a medical group at the staff level permits DIEMS Partners to include the physicians who contribute to the care of the same patients within a measurable service. The broader implications for quality, outcomes, and cost are obvious.

The DIEMS Partners program is more than a diagnostic service; it is a conduit for medical partnership that will permit implementation of quality improvement initiatives, retained patient base and shared savings.

DIEMS Partners Subscription Model

For a monthly rental fee under one-year, renewable contracts, DIEMS Partners will provide access to its testing equipment, database, communication administrative services, and accredited staff to provide the aforementioned diagnostic and communication services. Services are customizable within pre-defined management algorithms that have been demonstrated to be clinically indicated and necessary. Data will belong to DIEMS Partners and to its clients in order to foster accountability.

DIEMS Partners removes a clinic's resource barriers to point-of-care testing and the attendant benefit of rapid referral and focused care. Equally important, DIEMS Partners coordinated information management and data sharing will enable its clients to more quickly relate procedure to outcome by minimizing patient lost-to-follow up from their practice. DIEMS Partners algorithm-based approach and accredited vascular staff will assist in bringing uniformity to a client's diagnostic protocols and follow-up monitoring. The HL7 compatible and HIPAA-secure communication tools assure efficiency and confidentiality between physicians, medical practices, and patients.

The DIEMS Partners system provides a mechanism to build a strong referral network among teams dedicated to caring for patients who suffer from the syndromes of Diabetes and Polyvascular Disease.

Clinical Goals with the DIEMS Partners System

Potential clinical goals for implementation by the clinical members of the DIEMS Partners include the following:

Clinical Goals: to address “Time is Tissue” as an end-goal. Early detection is key to saving limbs and lives. Early detection is enabled by a system which is enabled: to provide accredited technicians who use quantified predictive tools for detecting alterations in perfusion and pressure that are indicative of underlying disease and which can be used to assess wound healing potential; to capture baseline data and track subsequent data for trending purposes, and assist with monitoring patients as they move between primary and referring physicians; to standardize diagnostic protocols; and to improve patient adherence to health-promoting practices.

Operational Goals: to improve patient management efficiency; to provide faster turn around time on noninvasive diagnostic tests; and to increase productivity within clinics and hospital.

Economic Goals: to provide tests that are reimbursed by payers or that can be justified to payers as cost-saving secondary to other measurable indicators of success; to provide a database for performance measures tied to therapy-enabling and therapy-guiding diagnostics; to demonstrate that medically economic diagnostic services help to reduce healthcare costs; to provide non-government pay for performance leadership by uniting local networks of physicians.

Practice Building Goals: to enhance outreach to referring physicians, thereby improving patient retention and building individual practices across multiple disciplines (e.g., wound care, nephrology, dialysis, podiatry, nursing care facilities); and developing strong referral ties to foster centers of excellence.

DIEMS Partners Program Description

The DIEMS Partners program may be implemented through an equipment and service rental program, facilitating the following client system and services:

Facilities: Client has an exam area that is available on a weeldy basis specifically for DIEMS Partners patient testing.

Clinic Type: DIEMS Partners establishes service sites in Dialysis Centers and Wound Care Centers as hubs for its patient services. Patients at these centers typically have the highest need for referred services and the most difficulty in following up with referred care.

Client will enter into an Equipment Rental Program which entitles the Client to pay for access to the equipment at their facility.

Client has the option to enter into a Staffing Agency Agreement with DIEMS Partners to pay for the services of DIEMS Partners' accredited technicians who will provide testing if necessary.

Client and DIEMS Partners will agree that a defined pool of new patients will be assessed for medically indicated conditions according to agreed upon diagnostic algorithms. Both parties will also agree that certain existing patients merit follow-up monitoring and will be assessed according to agreed upon diagnostic algorithms appropriate to them.

Client will enter into Service Agreement which entitles the Client to DIEMS Partners communication and database service program.

Client agrees to identify to DIEMS Partners referring physicians with whom they would like to primarily network patient care. There is neither obligation nor enforcement of this provision.

Client agrees within the confines of applicable law and HIPAA that DIEMS Partners can make Client's patient data available to Client's referral network wherein members of the referral base contribute to said patient's care. Data communication will be provided via DIEMS Partners secure database.

The Service Agreement allows Client to: a) access its patients' specific data as derived from testing performed at its clinic and at clinics within Client's referral network; b) access limited in-aggregate data from the network of DIEMS Partners Clients (non-referral network); and, c) create referral network connections.

The Service Agreement obligates Client to: a) encourage patients to accept referrals to best available treatment services that are recommended as result of this diagnostic service; b) notify DIEMS Partners of referral appointment.

DIEMS Partners will encourage patient to comply with referral appointment and will promptly notify Client of the patient's compliance with the referral appointment if the appointment is made within DIEMS Partners referral network, and also for out-of-network appointments where information sharing is authorized. Referral outside the network is not prohibited but compliance with appointment, data sharing and other patient information will likely not be available—and this makes DIEMS Partners program goals less attainable.

In further embodiments, the DIEMS Partners system will bill Medicare for tests ordered by the Medical Director according to clinically indicated need. In still further embodiments, the DIEMS Partners system will also provide notification of patient noncompliance with in-referral network appointment, such as missed appointments.

“Spoke” clients pay a fixed amount (such as per month) for these services. This amount will be allocated in percentages between Client and its network partners (e.g., Wound Care Clinic, Interventionist, Vascular Surgeon, and Podiatrist).

It is recognized that numerous modifications and adaptations to the above-described business model may be developed in conjunction with use of the DIEMS Partners system, and that the DIEMS Partners business model described above is only one example of a service implementing the DIEMS system.

Benefits to Clients with a Hub and Spoke Configuration

The DIEMS Partners diagnostic service is different and superior to other diagnostic/mobile services because it provides a total solution for a complex patient group and it is easy to implement in low-tech/low-cost settings. This model succeeds in large part because it combines proprietary technologies with familiar database management and patient feedback methods. There is much less risk versus other diagnostic service models because the technologies that are contemplated herein are high value but very simple to implement.

Specifically, the DIEMS service provides value to:

Patients: Simple tests and services that do not cause physical pain or “white coat” reaction and that can provide immediate information and regular feedback have been documented to encourage patient interest, cooperation, and adherence.

Providers: Wound Care Centers: Certified to manage patients with chronic disease conditions, these centers have multi-disciplinary teams who need to heal wounds quickly. A service that specifically refers patients to the “best practice” Wound Care Centers (shortest time-to-heal) will be preferred.

Providers: Vascular Specialists: Trained to perform highly technical procedures, the best outcomes are provided by those interventionists who perform the most procedures.

Providers: Dialysis Centers: Paid for high-volume, rapid through-put of patients, these centers are in difficult situation when it comes to managing other co-morbidities such as lower extremity ulcers. Their focus is to keep patients in treatment with no interruption and no emergency costs. The centers want services that can help accomplish this at a lower cost than that which is incurred by high turnover in patients secondary to hospitalization/death.

Payors: Insurance providers benefit most by keeping the highest cost patients out of hospitals and in a maintenance stage in terms of health. This can be significant from the point of view of controlling Medicare costs because implementation will eventually get heretofore unmanaged patients in an improved condition and prospectively enter new enrollees into a program that effectively holds down costs while maximizing health.

Online Collaborative Environment

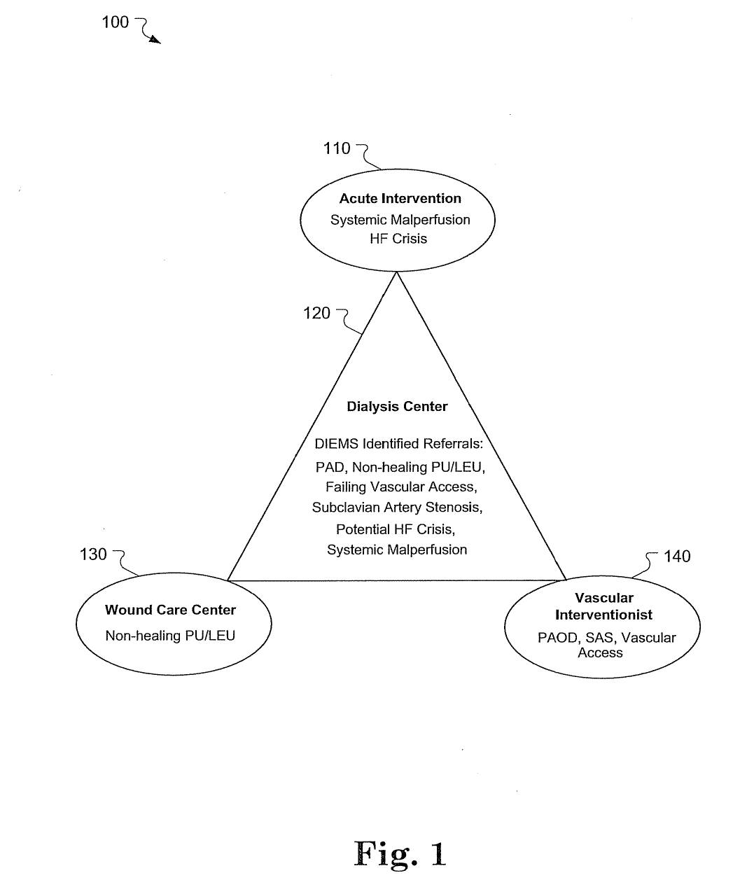

FIG. 1 depicts a collaborative hub-and-spoke configuration 100 facilitating interaction between various medical providers with the DIEMS solution according to one embodiment of the present invention. In the depicted embodiment, an acute intervention facility 110, wound care center 130, and vascular interventionist 140 are each connected to each other and a dialysis center 120 through the DIEMS system.

It is not unusual for patient care to become splintered between the myriad of specialized medical disciplines. This may be resultant and often dictated by the type of event a patient experiences (e.g., cardiac, renal, endocrine, trauma, wound, foot, etc.) and may be further complicated by the specific “protocol” employed by the specialized care provider for that specific event. A patient with multiple medical conditions is frequently referred to one “specialist” after another. Each health care provider treats the core patient in their areas of expertise yet cumulatively providing fragmented care. Despite best efforts for effective and timely communication between the specialties, delays or lack of communication are not uncommon. The advantage of DIEMS system is that it systematically and deliberately bridges the fractured disciplines to provide timely communication of pertinent health information to the primary and referring physician groups.

In this depicted example, the acute intervention facility 110 is equipped to respond to systemic malperfusion and any heart failure crises. The wound care center 130 is equipped to treat non-healing pressure ulcers (PU) and lower extremity ulcerations (LEU). The vascular interventionist 140 is equipped to diagnose and treat PAOD (Peripheral Arterial Occlusive Disease), SAS (Subclavian Artery Stenosis), and perform Vascular Access procedures.

Each of the healthcare providers 110, 130, 140 is connected to activities occurring at the “hub” dialysis center 120 through the DIEMS system. At the dialysis center 120, numerous tests and status updates will be collected for the patient as the patient makes consistent visits to the center. Therefore, referrals into the DIEMS Partners program are easily identified at the dialysis center 120. The Dialysis Center can collect data relevant to the diagnosis of a number of conditions, such as PAD; non-healing PU/LEU; failing vascular access; SAS; potential heart failure crises; and systemic malperfusion.

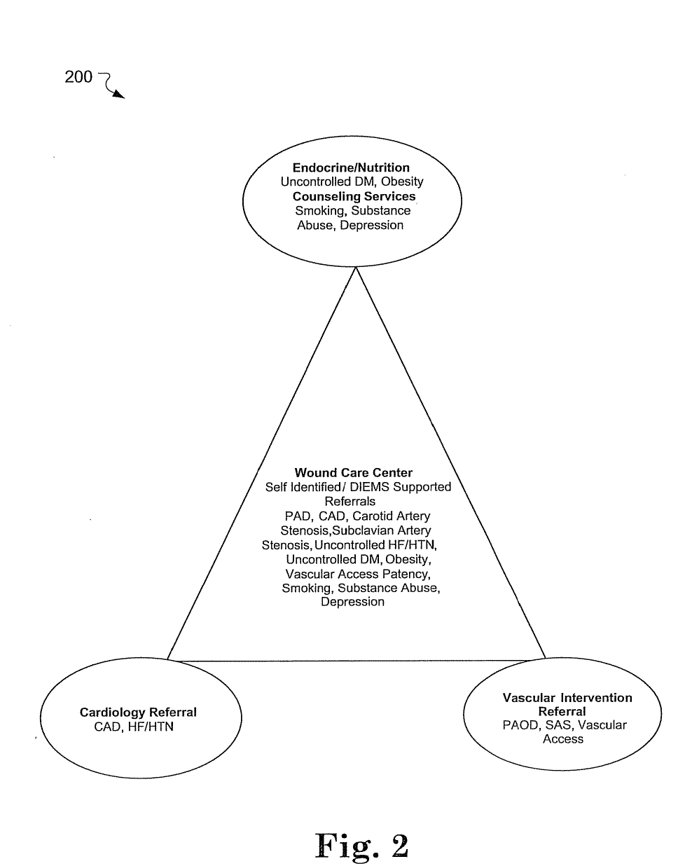

As an illustration of a further embodiment, FIG. 2 depicts a DIEMS Partners Supported Program Wound Care Center Hub with Spoke Network Partners 200, including: Interventionists, Vascular Surgeons, and Support Service Providers (e.g., Endocrinology, Diabetology, Nutrition, Counseling).

DIEMS System Configuration and Interactions

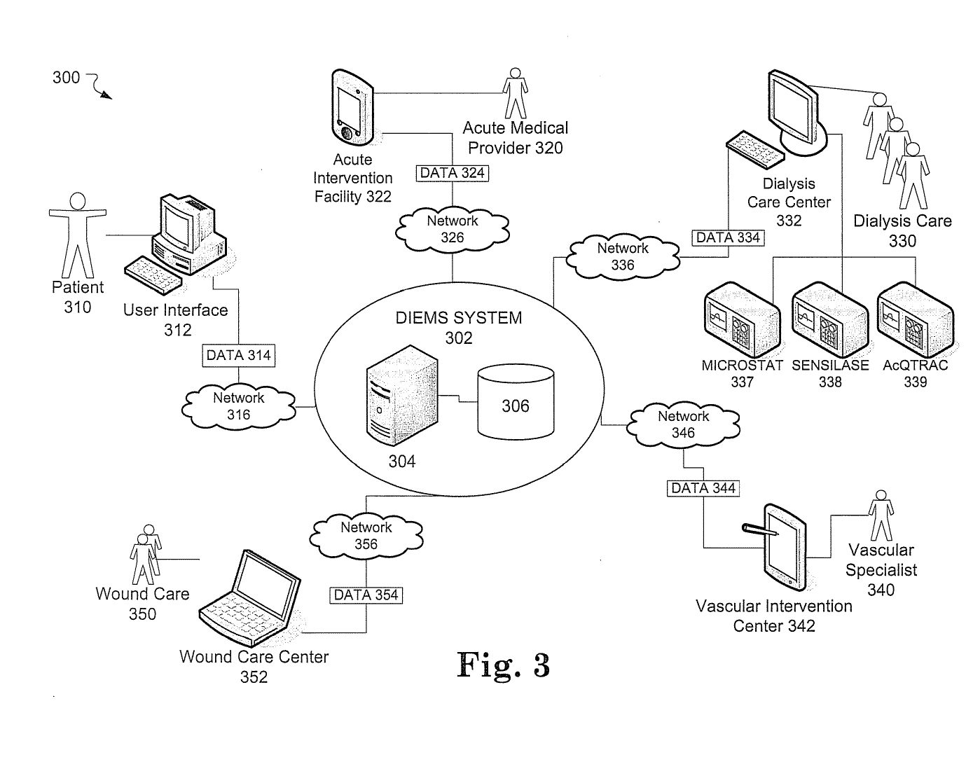

FIG. 3 depicts various the electronic components operated by medical providers and a patient interacting within operation 300 of the DIEMS system according to one embodiment of the present invention. As shown, the DIEMS electronic processing system 302 at the center of FIG. 3 contains both data processing capabilities in computer hardware 304, and data management capabilities in data store 306. These connections utilize wired methods, wireless methods, or a combination of wired and wireless methods.

Each of the various participants in the DIEMS Partners system is connected to the electronically operated DIEMS system 302 through various network connections. The patient 310 connects to the DIEMS system 302 over a network 316 with use of a user interface 312. In one embodiment, this user interface is a customer-driven website that provides information and control customized for patient needs. Accordingly, data 314 is transmitted between the patient user interface 312 and the DIEMS system 302 over the network 316.

Likewise, numerous medical providers are connected to the DIEMS system 302. Acute Medical Provider 320 at an Acute Intervention Facility 322 (such as a hospital) also accesses the DIEMS system 302 through network 326. The data 324 transmitted between the facility 322 and the DIEMS system 302 includes data relevant to the user's conditions, such as data related to the treatment and management of systemic malperfusion, heart failure crisis, or other acute Polyvascular conditions.

Dialysis care center 332 is also connected to the DIEMS system 302 through network 336. As shown, a number of care agents 330 are involved with the care center 332, as a number of disparate services are provided to the patient at the care center. The data 334 transmitted between the care center 332 and the DIEMS system 302 includes data related to referrals, PAD, non-healing PU/LEU, failing vascular access, SAS, potential heart failure crises, and systemic malperfusion. Additionally, a number of medical devices operate at the care center to collect and transmit data 334 of the patient once the patent is being treated at the care center 332. These devices include medical devices collecting data related to Polyvascular conditions and treatment, such as the MICROSTAT® 337, SENSILASE® 338, and ACQTRAC® 339 devices.

Vascular Intervention Center 342 is also connected to the DIEMS system 302 over the network 346. The Vascular Interventionist specialist 340 at a Vascular Intervention Center 342 also accesses the DIEMS system 302 through network 346. The data 344 transmitted between the Intervention Center 342 and the DIEMS system 302 also includes data relevant to the user's conditions, such as data related to the treatment and management of PAOD, SAS, and vascular access procedures.

Wound care center 352 is also connected to the DIEMS system 302 over the network 356. The wound care professionals 350 at the wound care center 352 provide data 354 to the DIEMS system 302 related to non-healing pressure ulcers and lower extremity ulcerations. Accordingly, the status of the ulcerations and its treatment may be monitored to be apprised of any significant progression of Polyvascular disease conditions.

As shown in FIG. 3, a variety of electronic computing devices, such as portable computers, smartphones, tablet PCs, servers, and the like, may be used to interface with the DIEMS system 304. Electronic information that is exchanged within the networks and to the DIEMS system 304 will be encoded, communicated, transported, processed, and archived using industry recognized standards such as Health Level Seven (HL7) while complying to HIPAA standards in a secure fashion. As commonly known, HIPAA specifies the privacy controls that need to be in place. Relevant data safeguards within the DIEMS system include reasonable and appropriate administrative, technical, and physical safeguards to prevent intentional or unintentional use of protected health information. Those skilled in the art would recognize other types of usual and customary security methods to assure HIPAA-compliance. For example, such safeguards might include securing e-medical records with encryption, passcode protection and limiting access to passcodes, or shredding documents containing protected health information before discarding them.

Electronic Communication System and User Interface

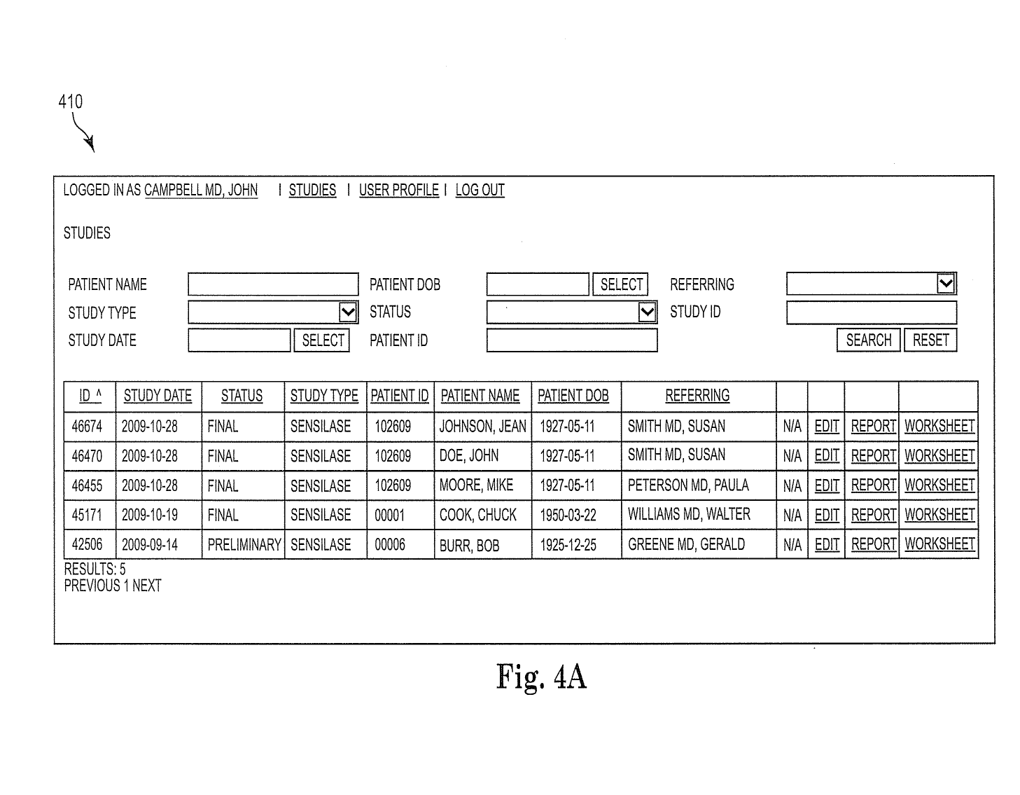

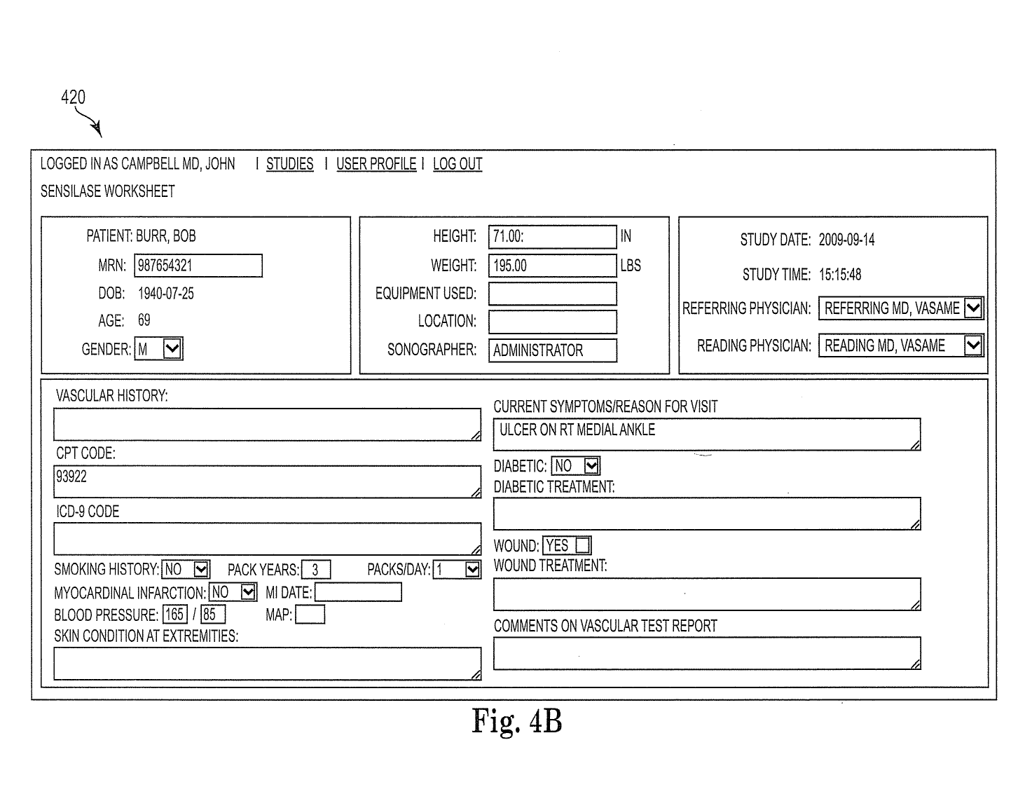

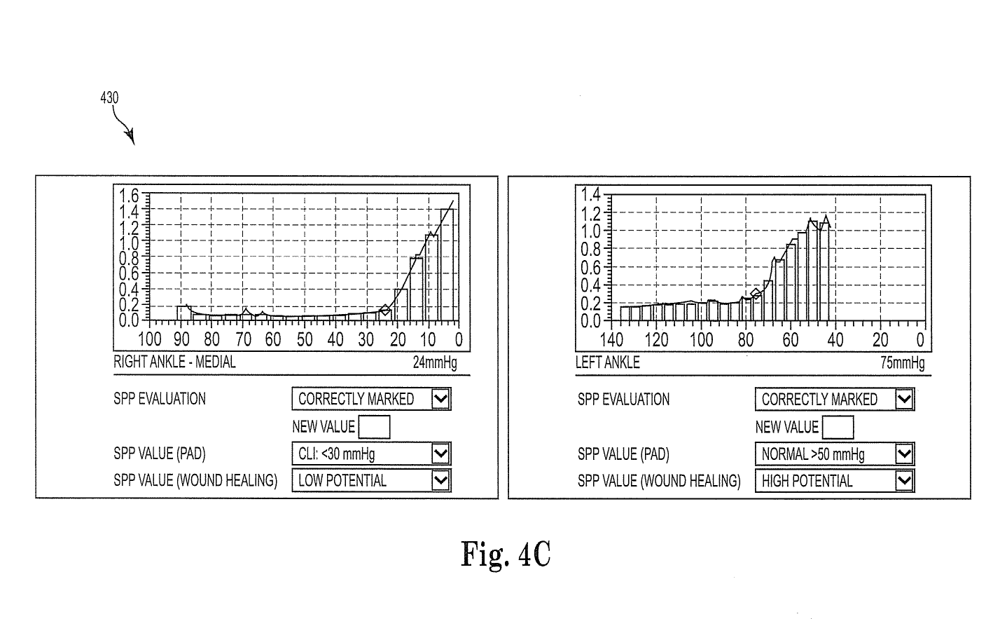

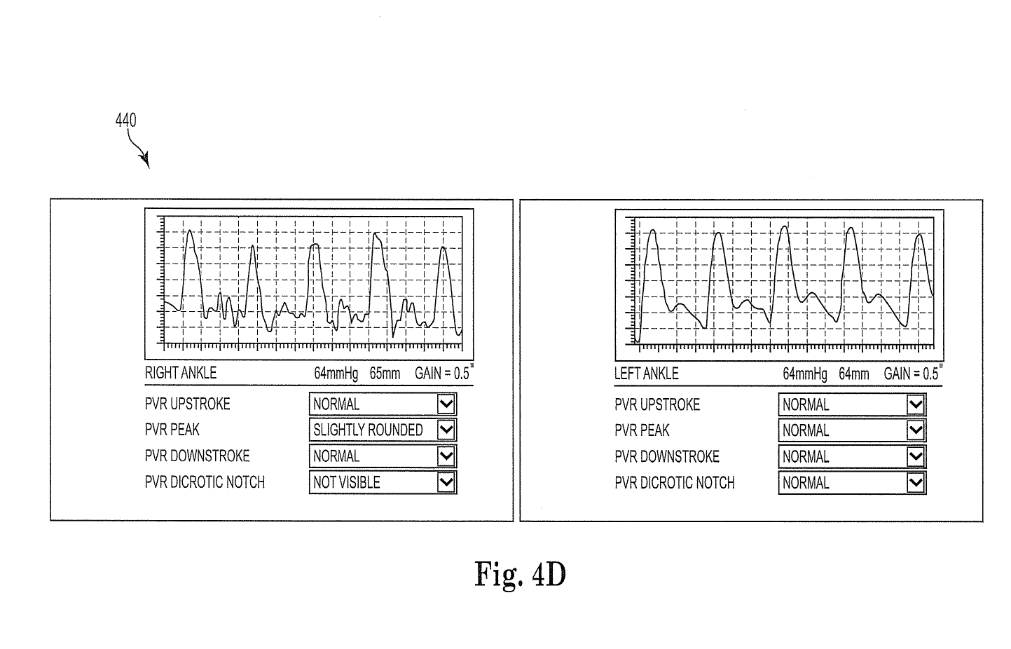

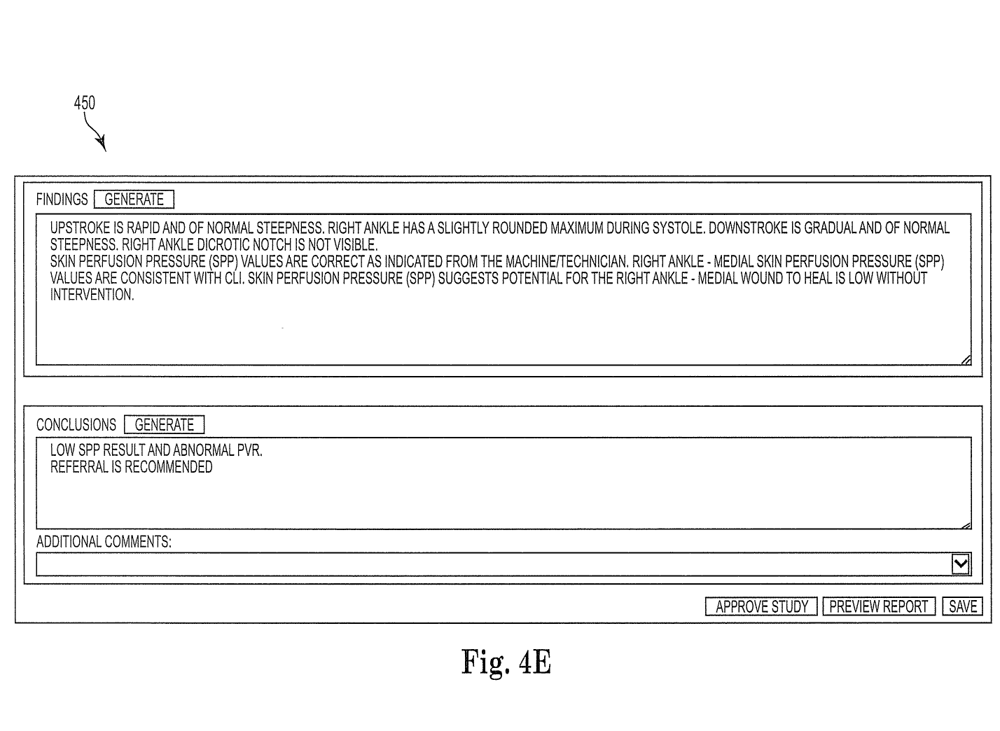

Aspects of the present invention may also be embodied through the configuration and use of an electronic communication system for the diagnosis, identification, treatment, and/or evaluation of polyvascular disease conditions. FIGS. 4A, 4B, 4C, 4D, and 4E each illustrate example user interfaces configured to allow referring and reading physicians to collect and communicate data on one or more polyvascular disease conditions in conjunction with the electronic communication system. In combination with the capabilities of the electronic communication system, these interfaces facilitate a simple and secure study interpretation process between multiple physicians and medical practices.

In one specific embodiment illustrated in FIG. 4A, the electronic communication system allows a referring physician to upload study data to the system through a web-based secure user interface. FIG. 4A depicts a list of patient studies 410 provided to the electronic communication system, with each patient study linked to further patient medical data and study information. As a non-limiting example, a microvascular health assessment may be performed on a plurality of patients by a plurality of referring physicians, collecting data through medical devices such as the SENSILASE® diagnostic system. Once data is uploaded and available via the system, a reading physician may be notified according to his or her preference, using methods such as email, SMS text messages, or other communications. The reading physician can then access the data within the user interface and provide interpretation of the studies.

Within this example medical data management website, either the referring or the reading physician may obtain access through use of secure login credentials. The views of patient data can be customized and filtered, and progress of report interpretation status can be monitored. Archived reports may also be available for future viewing or use.

FIG. 4B provides a more detailed interface screen 420 used for interpretation of a microvascular health study on a selected patient. Interpretive comments may be pre-configured for the physician from the electronic communication system in order to speed his or her review. The user interface may also provide drop-down menus to speed interpretation and selection of common analysis. Customization of comments and free-text comments may also be peimitted through the user interface. FIGS. 4C and 4D provide an example of graphical medical data 430, 440that may displayed through the user interface, combined with easy drop-down interface selections that allow a physician to quickly provide an evaluation.

Once the reading physician has selected appropriate interpretive comments for the medical data collected from the patient, findings may automatically generated. FIG. 4E illustrates an editable findings text interface 450 which displays a set of findings automatically generated by the electronic communication system. The findings and conclusion text may be modified and customized according to the reading physician's expertise. Once the reading physician selects the generate option, a report is generated and is ready for preview or approval. Once the approval option is selected, the complete report is posted to the secure website and the referring physician is notified.

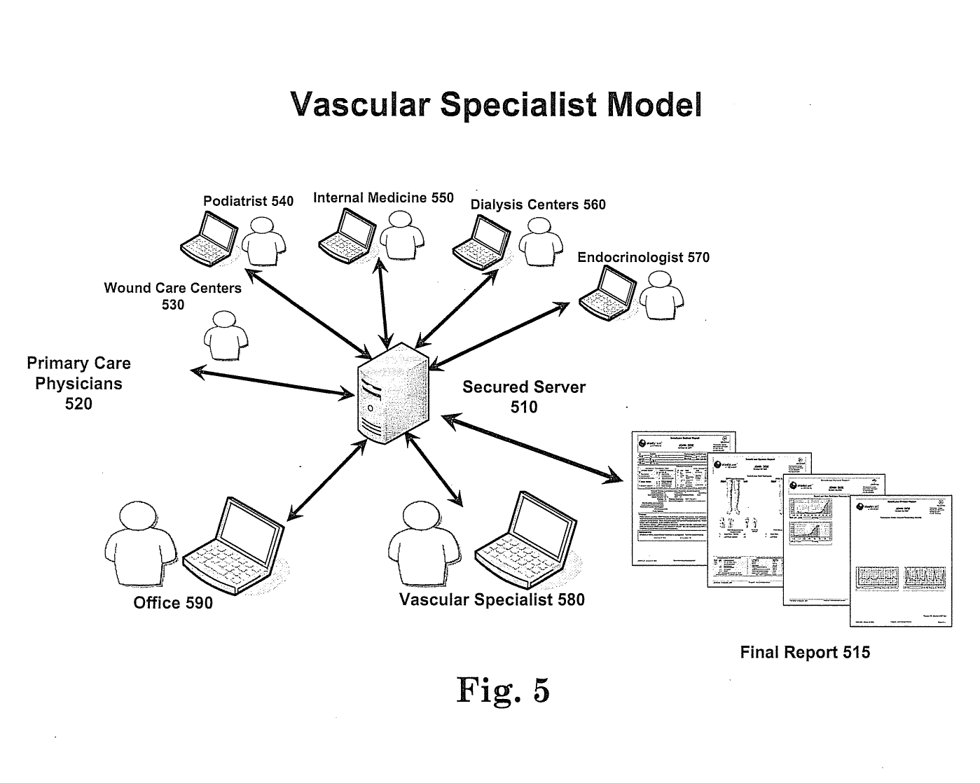

FIG. 5 provides another illustration of use of the electronic communication system in a vascular specialist model, through communications with a secured server 510. For example, this configuration facilitates an accurate and early identification of patients with PAD/CLI (Critical Limb Ischemia). Results may be automatically routed to a Vascular Specialist 580 for interpretation, and notifications of a complete final report 515 may be provided to the various medical providers 520, 530, 540, 550, 560, and 570 as applicable. The user interface accessing the secured server 510 also provides a customizable data management platform that may also be adapted for a variety of other polyvascular disease conditions.

In use, Primary Care Physicians 520 conduct tests, and use the secured server 510 to automatically transmit test results to the Vascular Specialist 580 for reading. The Primary Care Physicians 520 are provided with secure web based access to view final test interpretation and vascular specialist recommendations. Keeping the electronic data in one location through the secured server also enables reimbursement for the technical components of the study. An office 590 may also be involved in the vascular specialist model to facilitate automatic transmission of test reports for tracking data and documentation (e.g., Medicare, reimbursement, patient outcomes).

As previously suggested, the Vascular Specialist 580 is provided with rapid notification of pending tests to read. The Vascular Specialist 580 may access pending tests from any internet accessible computer. In this way, it is easy for the Vascular Specialist to identify patients needing further tests and the need for vascular therapy. Finally, the specialist's use of the secured server 510 allows easy tracking to allow reimbursement for professional interpretation.

Data Processing Centers and Algorithms

As previously stated, specific protocols or algorithms that dictate patient assessment and treatment on an event type basis are often present and dictated by either the individual care site, medical discipline, or both. As such, treatment modalities for the same type event may differ across specialties or clinics. For example, a comprehensive wound care clinic will typically have standardized treatment algorithms in place for many of the conditions they treat. All clinic personnel are educated in these standardized protocols or algorithms as they provide not only standardization of treatment but additionally offer guidance on optimal assessment/healing pathways that are evidence based and lead to effective healing and high outcome rates. The protocol/algorithm established from one corporate-supported wound care center may be different from a competitive corporate-supported wound care center whose algorithm may in turn differ from a vascular center. Regardless of these differences, the DIEMS system allows provision and access to the same types of patient related data to support patient effective treatment pathways, irrespective of the implemented, site-specific protocol algorithm.

It is acknowledged that the various components of the present invention may be embodied exclusively as or in combination with a system, method, device, or computer program product. Accordingly, the various aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the presently described invention may include a computer program product embodied in any tangible medium of expression having computer usable program code embodied in the medium.

Any combination of one or more computer usable or computer readable storage medium(s) may be utilized. The computer-usable or computer-readable storage medium may be, for example but not limited to, an electronic, magnetic, optical, electromagnetic, infrared, or semiconductor system, apparatus, device, or propagation medium. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable storage medium includes any suitable medium for use with a computer, as the program may be electronically captured from a medium, then compiled, interpreted, or otherwise processed in a suitable manner, if necessary, and then stored in a computer memory. In the context of this document, a computer-usable or computer-readable storage medium may be any medium that can contain, store, communicate, propagate, or transport the program for use by or in connection with the instruction execution system, apparatus, or device. The computer usable program code and the communications performed through the use of such code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as C++, C#, Java, Smalltalk or the like and conventional procedural programming languages, such “C” or similar procedural programming languages. The program code may execute on processors or other hardware contained entirely on a user's computer, partly on a user's computer, as a stand-alone software package, partly on a user's computer and partly on a remote computer, entirely on the remote computer or server, and/or in a virtualized or cloud computing environment. Remote computers may be connected to a user's computer through any type of network, including a local area network (LAN), a wide area network (WAN), a secure virtual private network (VPN) or intranet, or the connection may be made to an external computer (for example, through the Internet using an Internet Service Provider).

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A system, comprising:
a network;
an electronic processing system connected to the network, the electronic processing system configured to:
process data points received from a plurality of electronic computing devices and medical devices, the data points relating to one or more polyvascular disease conditions in a selected patient at a defined point in time; and
correlate the data points with historical data points relating to the one or more polyvascular disease conditions to calculate a progression of the one or more polyvascular disease conditions and related medical conditions in a selected patient; and
a user interface accessible via the network and connected to the electronic processing system via the network, the user interface configured to:
receive data collected from one or more medical providers;
display information regarding the one or more polyvascular disease conditions and the related medical conditions in the selected patient, including results of medical tests conducted on the selected patient and data collected from the plurality of medical devices; and
display the progression of the one or more polyvascular disease conditions and any related medical conditions in the selected patient.

2. The system of claim 1, wherein the user interface is further configured to allow a plurality of medical providers to communicate with each other regarding the progression of the one or more polyvascular disease conditions in the selected patient.

3. The system of claim 1, wherein the electronic computing devices and medical devices are connected to the electronic processing system through wired and wireless communication methods, including one or more of Ethernet, RS-232, RS-485, twisted-pair, Bluetooth, 802.11b, 802.11a, 802.11g, 802.11n, IrDA, digital transmission via cell phone transmission, text messaging, satellite transmission, and proprietary wireless channels.

4. The system of claim 1, wherein the electronic computing devices include one or more of portable computers, smartphones, tablet PCs, servers, and wherein the medical devices include one or more of a tissue capnometry system, a perfusion monitor, a cardiovascular monitor, a glucose monitor, a blood pressure monitor, and an ankle-brachial index monitor.

5. The system of claim 1, wherein the polyvascular disease conditions include peripheral arterial disease, diabetes mellitus, cerebrovascular disease, coronary artery disease, hypertension, lower extremity ulcers, peripheral neuropathy, chronic kidney disease, end-stage renal disease, intradialytic hypoperfusion, vascular access collapse, suspected subclavian arterial stenosis, malperfusion syndromes, and vascular access steal syndrome.

6. The system of claim 1, wherein the medical tests include one or more of skin perfusion pressure tests, diabetic foot assessment tests, vascular access patency assessments, local malperfusion tests, glucose level tests, mucosal tissue assessment, digit perfusion and arm pressure tests, and cardiovascular risk marker assessments.

7. The system of claim 1, wherein the data is processed and correlated in the electronic processing system through use of one or more data analysis techniques, including Bayesian probability techniques, fuzzy logic, and mathematical analysis.

8. An electronic system, comprising:
a device generating device data related to a first medical condition, the first medical condition being a polyvascular disease condition or associated with one or more polyvascular disease conditions;
a processing component configured to analyze and monitor the first medical condition, the processing component operably connected to the device, and the processing component executing a set of instructions within the electronic system for:
receiving the device data and examination results from a plurality of medical tests and evaluations conducted by a plurality of medical providers, the device data and the examination results being relevant to a status of the first medical condition;
analyzing the device data and the examination results relevant to the first medical condition within the electronic system;
correlating the device data and the examination results analyzed from the first medical condition to determine incidence of a second medical condition, the second medical condition being a polyvascular disease condition or associated with one or more polyvascular disease conditions; and
estimating a progression of the second medical condition in the patient; and
a plurality of user interfaces accessible by a plurality of medical providers, the user interfaces configured to:
receive results of the plurality of medical tests and evaluations conducted by the plurality of medical providers;
display analysis of the device data and the examination results relevant to the first medical condition to a selected medical provider; and
display the estimated progression of the second medical condition to the selected medical provider.

9. The electronic system of claim 8, wherein the polyvascular disease conditions include peripheral arterial disease, diabetes mellitus, cerebrovascular disease, coronary artery disease, hypertension, lower extremity ulcers, peripheral neuropathy, chronic kidney disease, end-stage renal disease, intradialytic hypoperfusion, vascular access collapse, suspected subclavian arterial stenosis, malperfusion syndromes, and vascular access steal syndrome.

10. The electronic system of claim 8, wherein the device includes one or more of a tissue capnometry system, a perfusion monitor, a cardiovascular monitor, a glucose monitor, a blood pressure monitor, and an ankle-brachial index monitor.

11. The electronic system of claim 8, wherein the medical tests and evaluations include one or more of skin perfusion pressure tests, diabetic foot assessment tests, vascular access patency assessments, local malperfusion tests, glucose level tests, mucosal tissue assessment, digit perfusion and arm pressure tests, and cardiovascular risk marker assessments.

12. The electronic system of claim 8, wherein the device data and examination data is correlated through use of one or more data analysis techniques, including Bayesian probability techniques, fuzzy logic, and mathematical analysis.

13. The electronic system of claim 8, wherein the medical providers include primary care medical practices, specialty care medical practices, dialysis clinics, wound care clinics, and limb preservation clinics.

14. The electronic system of claim 8, wherein the plurality of user interfaces are websites requiring secure authentication and are remotely accessible by the plurality of medical providers.

15. The electronic system of claim 8, wherein the plurality of user interfaces are further configured to provide HL7-compliant and HIPPA-compliant secure communications between the plurality of medical providers.

16. A method using an electronic system, comprising:
collecting medical data relevant to polyvascular disease conditions for a patient, the medical data originating from evaluations conducted by a plurality of medical providers, results from a plurality of medical tests, and device data collected from a plurality of medical devices;
processing the medical data within the electronic system to recognize medical data relevant to a first polyvascular disease condition;
correlating the medical data relevant to the first polyvascular disease condition to determine incidence of a second medical condition, the second medical condition being a polyvascular disease condition or associated with a polyvascular disease condition;
calculating progression of the second medical condition in the patient using the correlated medical data; and
transmitting analysis and the calculated progression of the second medical condition from the electronic system to a selected medical provider.

17. The method of claim 16, wherein collecting medical data relevant to polyvascular disease conditions for a patient further includes collecting the medical data over a defined period of time to produce a plurality of data points.

18. The method of claim 16, wherein the polyvascular disease conditions include peripheral arterial disease, diabetes mellitus, cerebrovascular disease, coronary artery disease, hypertension, lower extremity ulcers, peripheral neuropathy, chronic kidney disease, end-stage renal disease, intradialytic hypoperfusion, vascular access collapse, suspected subclavian arterial stenosis, malperfusion syndromes, and vascular access steal syndrome.

19. The method of claim 16, wherein the medical devices include one or more of a tissue capnometry system, a perfusion monitor, a cardiovascular monitor, a glucose monitor, a blood pressure monitor, and an anlde-brachial index monitor.

20. The method of claim 16, wherein the medical tests include one or more of skin perfusion pressure tests, diabetic foot assessment tests, vascular access patency assessments, local malperfusion tests, glucose level tests, mucosal tissue assessment, digit perfusion and arm pressure tests, and cardiovascular risk marker assessments.

21. The method of claim 16, wherein the data is correlated through use of one or more data analysis techniques, including Bayesian probability techniques, fuzzy logic, and mathematical analysis.

22. The method of claim 16, further comprising tracking and comparing progression of the first polyvascular disease condition and the second medical condition for trending purposes.

23. The method of claim 16, wherein the medical providers include one or more of primary care medical practices, specialty care medical practices, dialysis clinics, wound care clinics, and limb preservation clinics.

24. The method of claim 16, wherein the electronic system is an internet-accessible processing service accessible by the plurality of medical providers through a website.
